(19) United States
(12) Patent Application Publication
(10) Pub. No.: US 2005/0162427 A1
(43) Pub. Date: Jul. 28, 2005

(54) Font processor, terminal device, font processing method, and font processing program

(75) Inventors: Yukinobu Momozono, Kagoshima-shi (JP); Takashi Kurumisawa, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/648,368

(22) Filed: Aug. 27, 2003

(30) Foreign Application Priority Data
Aug. 30, 2002 (JP) 2002-255259

(51) Int. Cl. G06T 11/00; G09G 5/00

(52) U.S. Cl. 345/467; 345/613

(57) ABSTRACT

The invention provides a font processor that is able to display bitmap fonts used in a mobile phone, a PDA, or the like with a small amount of computation and with high quality. A font processor of the present invention can acquire predetermined data of the bitmap fonts and analyzes the pixel arrangement of the acquired font data by pattern matching. The font processor then generates subpixel fonts that have data in subpixels constituting the pixel of the font data in accordance with the pixel arrangement. A subpixel is an element constituting a pixel. A collection of three subpixels, that is, R (red), G (green), and B (blue) subpixels, generally constitutes one pixel. Analyzing the pixel arrangement and generating the subpixel fonts that are collections of data in subpixels increase the apparent resolution of the font data. Accordingly, finer lines can be drawn and jaggies occurring in diagonal lines of the font data in pixels can be reduced. Performing the processing described above by pattern matching requires only a small amount of computation.

### BACKGROUND OF THE INVENTION

1. Field of Invention

The present invention relates to a technique for improving the display quality of relatively small bitmap fonts used for mobile phones or the like.

2. Description of Related Art

Bitmap fonts are used for displaying characters in devices, such as mobile phones and personal digital assistants (PDAs). Bitmap fonts display characters, symbols, and so on by using predetermined array patterns of pixels. Unlike outline fonts that display characters, symbols, and so on as a collection of vector data, bitmap fonts are simple array patterns of pixels, so that the amount of data per character is small. Accordingly, bitmap fonts are used in mobile phones, PDAs, or the like, which have a relatively small number of pixels in their display area.

In recent years, the popularization of mobile phones, PDAs, and the like allows users to freely exchange email or browse web sites using such portable terminals. Hence, the opportunities for users to read characters on displays, such as mobile phones, have increased, and therefore it is desired that the display quality of the characters be improved.

### SUMMARY OF THE INVENTION

Techniques for displaying high-quality fonts on a liquid crystal display device, such as a mobile phone or a PDA, include a technique for improving the display quality by expressing bitmap fonts in subpixels. For example, an LC (liquid crystal) font technology developed by Sharp Corporation is known as such a technique.

In a liquid crystal display, a collection of three picture elements for R (red), G (green), and B (blue), which are called subpixels, constitutes one color picture element. One color picture element is called a “pixel” and each of the three picture elements constituting the pixel is called a “subpixel”. The LC font technology processes patterns of the bitmap fonts in subpixels. Namely, the dot pattern of alphabetic data of a bitmap font is determined and a skeleton of characters in subpixels is extracted in order to display the bitmap font. Setting a stepwise luminance-varying pattern that makes use of human visual performance around the extracted skeleton reduces so-called jaggies in diagonal lines of characters or in curves of the characters, thereby improving the display quality of the characters.

However, since the skeleton extraction process in the LC font technology described above analyzes the structure of the bitmap fonts in subpixels by pattern determination or the like to extract the skeleton, the amount of computation required for the process undesirably increases.

Accordingly, an object of the present invention is to be able to display the bitmap fonts used in mobile phones, PDAs, or the like with a small amount of computation and with high quality.

The present invention, in its first aspect, can provide a font processor including a data acquiring device for acquiring font data of bitmap fonts, a subpixel-font generating device for analyzing the pixel arrangement of the font data by pattern matching to generate subpixel fonts that have data in subpixels, and gradation controlling device for controlling the gradation levels of the subpixels constituting the subpixel fonts.

The present invention, in its second aspect, can provide a font processing method including a data acquiring step for acquiring font data of bitmap fonts, a subpixel-font generating step for analyzing the pixel arrangement of the font data by pattern matching to generate subpixel fonts that have data in subpixels, and a gradation controlling step for controlling the gradation levels of the subpixels constituting the subpixel fonts.

The font processor or the font processing method described above acquires predetermined data of the bitmap fonts and analyzes the pixel arrangement of the acquired font data by pattern matching. The font processor or the font processing method then generates the subpixel fonts that have data in subpixels constituting the pixels of the font data in accordance with the pixel arrangement. A subpixel is an element constituting a pixel. A collection of three subpixels, that is, R (red), G (green), and B (blue) subpixels, generally constitutes one pixel. Analyzing the pixel arrangement and generating the subpixel fonts that are collections of data in subpixels increases the apparent resolution of the font data, so that finer lines can be drawn. As a result, jaggies occurring in diagonal lines of the font data in pixels can be reduced.

The font processor described above controls the gradation level of each of the subpixels constituting a subpixel font, thereby smoothly displaying the outline and the like of the font.

In one mode of the font processor, when pixels constituting the font data are adjacently arranged in a diagonal line, the subpixel-font generating device may horizontally shift the subpixels constituting the pixels by a predetermined number of subpixels.

Shifting the pixel data in subpixels in the diagonal lines of the original font data in this mode eliminates jaggies in the diagonal lines, thus achieving smooth display.

Specifically, the subpixel-font generating device preferably shifts the subpixels constituting the pixels left when the pixels constituting the font data are adjacently arranged in a left diagonal line, while the subpixel-font generating device preferably shifts the subpixels constituting the pixels right when the pixels constituting the font data are adjacently arranged in a right diagonal line. Also, the subpixel-font generating device preferably places the subpixels constituting the pixels at the positions of the corresponding pixels when the pixels constituting the font data are arranged in a horizontal line or in a vertical line.

In the font processor according to an embodiment, the subpixel-font generating device may perform pattern matching using a matching pattern of 3×3 pixels. The use of a small pattern on the order of 3×3 pixels greatly decreases the amount of computation required for the pattern matching, thus reducing the load on the processor or the like and increasing the speed of the processing.

In another mode of the font processor, the gradation controlling device may include edge detecting device for detecting edges included in the subpixel fonts and gradation setting device for setting the gradation level of the pixels constituting the edges to an intermediate gradation level.

Since the gradation level of the pixels in the edges included in the subpixel fonts, that is, in the part corresponding to the outline of the character, is set to an intermediate gradation level, not to two values of white and black, in this mode, the outline of the character can be smoothly displayed.

The edge detecting device preferably detects as the edges portions where pixels constituting a character are horizontally adjacent to pixels constituting a background. The gradation setting device preferably increases the gradation level of the pixels constituting the character by a predetermined percentage and decreases the gradation level of the pixels constituting the background by the same predetermined percentage. The predetermined percentage depends on the characteristics of the display device for displaying the fonts and so on.

The present invention, in its third aspect, can provide a terminal device including the font processor described above, a storage device that stores the font data generated by the font processor, and a display unit for displaying the font data generated by the font processor.

The present invention, in its fourth aspect, can provide a font processing program executed in a terminal device having a computer. The font processing program causes the computer to function as a data acquiring device for acquiring font data of bitmap fonts, a subpixel-font generating device for analyzing the pixel arrangement of the font data by pattern matching to generate subpixel fonts that have data in subpixels, and a gradation controlling device for controlling the gradation levels of the subpixels constituting the subpixel fonts.

Executing the font processing program described above on a terminal device, such as a mobile phone or a PDA, embodies the font processor, so that characters having reduced jaggies and smooth outlines can be displayed with a small amount of computation.

### BRIEF DESCRIPTION OF THE DRAWINGS

The invention will be described with reference to the accompanying drawings, wherein like numerals reference like elements, and wherein:

FIG. 1 schematically shows the structure of a mobile terminal device using a process for improving the character quality of bitmap fonts of the present invention;

FIG. 2 is a flowchart of the process for improving the character quality of bitmap fonts;

FIG. 3 is a flowchart of an expansion process into subpixels shown in FIG. 2;

FIG. 4 includes example patterns used for pattern matching in the expansion process into subpixels;

FIG. 5 includes other example patterns used for the pattern matching in the expansion process into subpixels;

FIG. 6 includes examples of the font structures before and after the expansion process into subpixels and after a multi-gradation process according to the present invention; and

FIG. 7 is a flowchart of the multi-gradation process in the expansion process into subpixels.

### DETAILED DESCRIPTION OF PREFERRED EMBODIMENTS

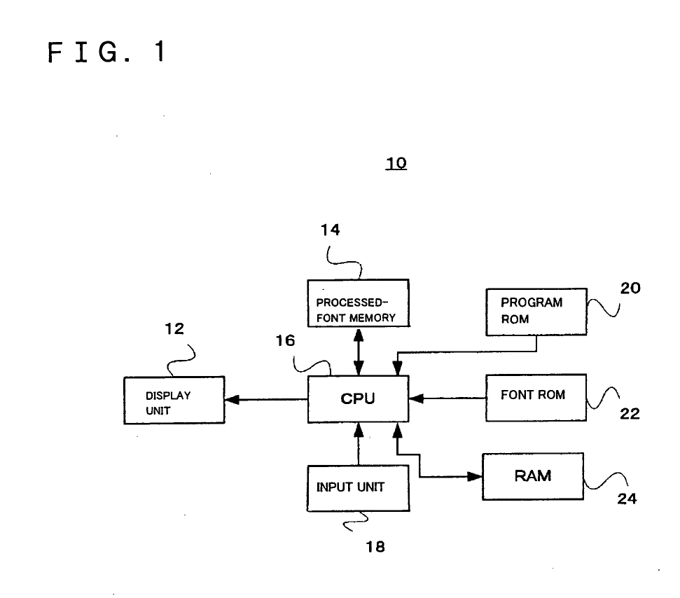

Preferred embodiments of the present invention will now be described with reference to the attached drawings. FIG. 1 schematically shows the structure of a mobile terminal device 10 using the process for improving the character quality of bitmap fonts according to an embodiment of the present invention. Referring to FIG. 1, the mobile terminal device 10 can be a terminal device having a relatively small image display area, such as a mobile phone or a personal digital assistant (PDA). The mobile terminal device 10 has a display unit 12, a processed-font memory 14, a CPU 16, an input unit 18, a program ROM 20, a font ROM 22, and a RAM 24.

The display unit 12 is a lightweight and thin display, such as a liquid crystal display (LCD), for displaying the characters expressed by the bitmap fonts in a display area.

The input unit 18 can be embodied by operation buttons for a mobile phone or by a tablet for detecting contact with a touch pen or the like for a PDA. The input unit 18 is used for various instructions or selections by a user. The instructions or selections input with the input unit 18 are converted to electrical signals to be transmitted to the CPU 16.

The program ROM 20 stores various programs for executing various functions of the mobile terminal device 10. In particular, according to this embodiment, the program ROM 20 stores a program for improving the character quality of the bitmap fonts, a program for displaying the characters using the bitmap fonts, and so on.

The font ROM 22 stores original data (also referred to as “alphabetic data”) of the bitmap fonts. The original data of the bitmap fonts are generally fonts having a length that are equal to the width (also referred to as “square fonts”), such as 16×16 dots.

The RAM 24 is used as a working memory when the original data of the bitmap fonts are processed in accordance with the program for improving the character quality of the bitmap fonts. The processed-font memory 14 is a memory for temporarily storing the fonts (hereinafter also referred to as processed fonts), the quality of which has been improved by the program for improving the character quality. The processed-font memory 14 is generally a RAM or a flash memory, which stores the contents until the mobile terminal device 10 is turned off.

The CPU 16 carries out various functions of the mobile terminal device 10 by executing various programs stored in the program ROM 20. In particular, according to this embodiment, the CPU 16 reads out the program for displaying the characters, stored in the program ROM 20, and executes the program that is read out in order to display the characters on the display unit 12. The CPU 16 also reads out the program for improving the character quality, stored in the program ROM 20, and executes the program that is read out in order to generate processed fonts having higher display quality than the bitmap fonts stored in the font ROM 22. Although the CPU 16 executes various programs to implement various functions of the mobile terminal device 10, in addition to the functions described above, the description of the various functions is omitted because they are not directly related to the present invention.

The process for improving the character quality will now be described. The process for improving the character quality according to the present invention improves the display quality, as a basic principle, by processing the bitmap fonts in subpixels constituting the bitmap fonts. Specifically, the process generates subpixel fonts from the alphabetic data of the bitmap fonts to be displayed and then performs a multi-gradation process for the subpixel fonts. This process will be sequentially described.

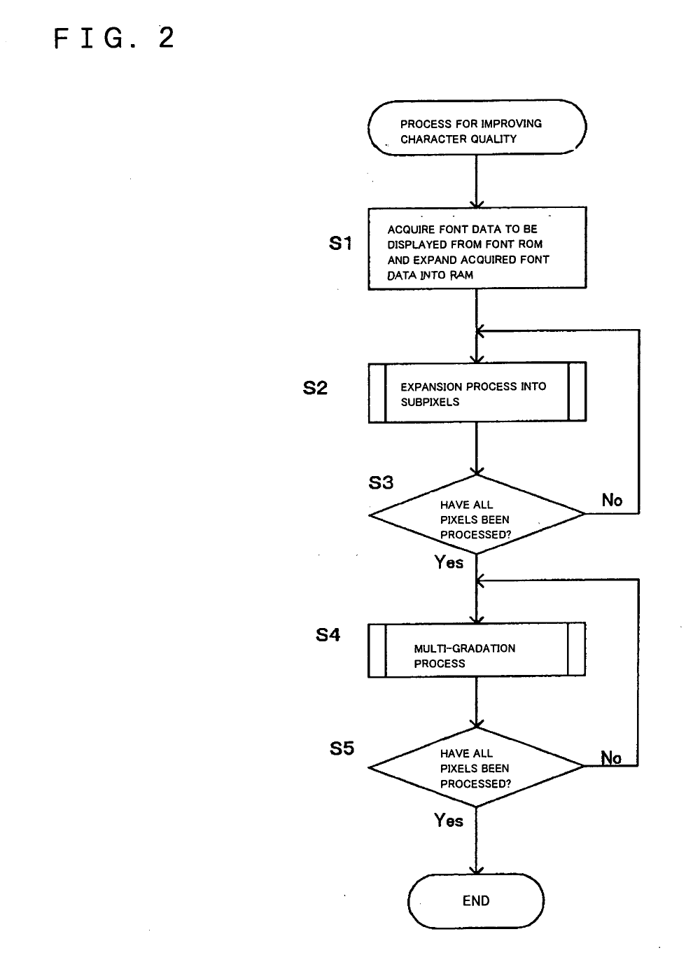

FIG. 2 is a flowchart of the process for improving the character quality. The process is performed by the CPU 16 (FIG. 1), which executes the program for improving the character quality stored in the program ROM 20 to control the font ROM 22 and the RAM 24.

When the display unit 12 of the mobile terminal device 10 is ready to display certain characters in accordance with the instructions given by the user or the like, the CPU 16 acquires the font data (alphabetic data) to be displayed from the font ROM 22 and expands the acquired data in the RAM 24 serving as the working memory (Step S1).

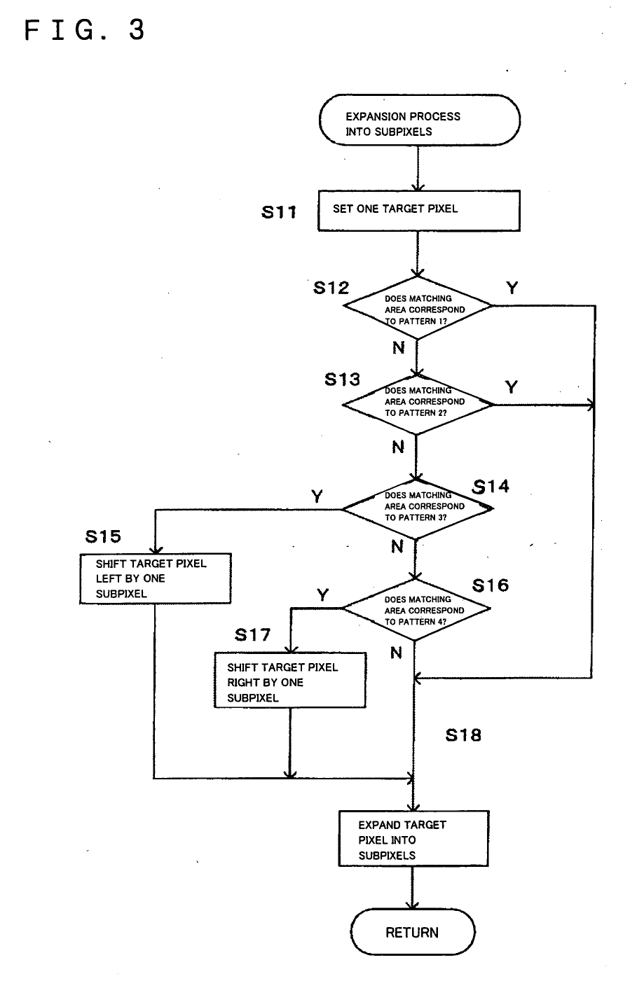

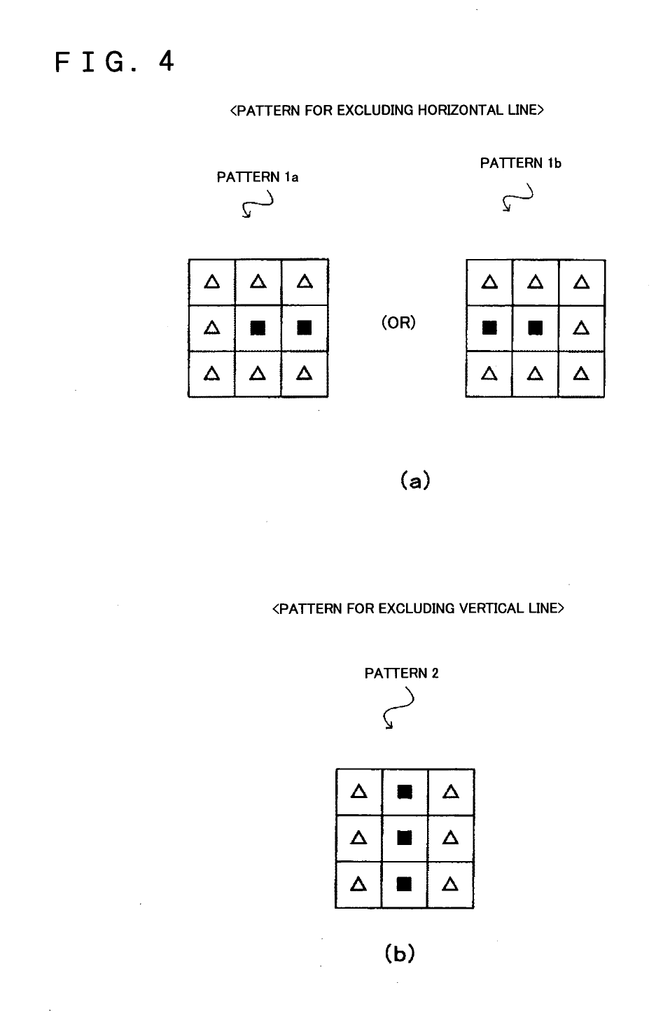

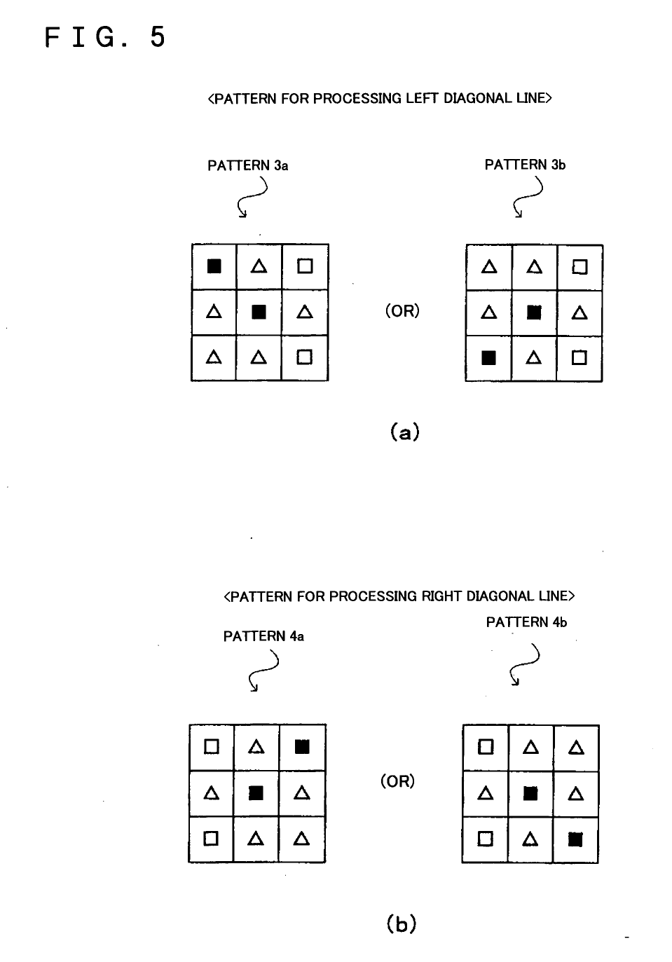

Next, the CPU 16 performs an expansion process into the subpixels (Step S2). FIG. 3 shows the expansion process into the subpixels in detail. The expansion process performs pattern matching in pixels for the bitmap fonts expanded in the RAM 24 to generate subpixel fonts that have reduced jaggies and the like occurring in diagonal lines of the fonts. Specifically, each pixel (a collection of subpixels) of the bitmap fonts expanded in the RAM 24 in Step S1 is set as a pixel to be processed (referred to as target pixel), and the pattern matching is performed for the target pixel and a pixel area surrounding it. To be more precise, the pattern matching is performed for eight pixels surrounding the target pixel (hereinafter referred to as a matching area). Pattern examples used for the pattern matching are shown in FIGS. 4 and 5. In each pattern shown in FIGS. 4 and 5, the central pixel is the target pixel. A symbol ▪ denotes a pixel constituting a character, a symbol □ denotes a pixel constituting a background, and a symbol A denotes a pixel having no preference (a pixel not to be compared).

Referring to FIG. 3, the CPU 16 sets one target pixel from among the bitmap fonts expanded in the RAM 24 in Step S1 (Step S11). The target pixel is set only to the pixels constituting the character among the pixels contained in the bitmap fonts. Namely, the pixels constituting the background are skipped and are not set as the target pixel.

The CPU 16 then determines whether the matching area of 3×3 dots including the target pixel corresponds to a pattern 1a or a pattern 1b shown in FIG. 4(a) (Step S12). The patterns 1a and 1b are patterns for detecting horizontal lines in the bitmap fonts. When a pixel at the left or right of the target pixel is a pixel constituting a character (▪), the matching area corresponds to the pattern 1a or 1b. Since, in the arrangement of the bitmap fonts, jaggies do not occur in an area corresponding to a horizontal line, that is, in an area where the pixels constituting the character are horizontally arranged, this area is excluded from the target for shift in subpixels. Accordingly, when the matching area corresponds to the pattern 1a or 1b (the determination result is Yes in Step S12), the target pixel is expanded into the subpixels without shift in subpixels (Step S18) and the process terminates the processing of the target pixel.

In contrast, when the matching area does not correspond to the pattern 1a or 1b (the determination result is No in Step S12), the CPU 16 determines whether the matching area corresponds to a pattern 2 shown in FIG. 4(b) (Step S13). The pattern 2 is a pattern for detecting a vertical line. When both a pixel above the target pixel and a pixel below the target pixel are pixels constituting the character (▪), the matching area corresponds to the pattern 2. Since, in the arrangement of the bitmap fonts, jaggies do not occur in an area corresponding to a vertical line, that is, in an area where the pixels constituting the character are vertically arranged, this area is excluded from the target for shift in subpixels. Accordingly, when the matching area corresponds to the pattern 2 (the determination result is Yes in Step S13), the target pixel is expanded into the subpixels without shift in subpixels (Step S18) and the process terminates the processing of the target pixel.

In contrast, when the matching area does not correspond to the pattern 2 (the determination result is No in Step S13), the CPU 16 determines whether the matching area corresponds to a pattern 3a or 3b shown in FIG. 5(a) (Step S14). The patterns 3a and 3b are patterns for detecting left diagonal lines. When an upper-left pixel or a lower-left pixel of the target pixel is a pixel constituting the character (▪) and an upper-right pixel and a lower-right pixel of the target pixel are pixels constituting the background (□), the matching area corresponds to the pattern 3a or 3b.

The left diagonal lines are where jaggies occur in the arrangement of the bitmap fonts. Accordingly, when the matching area corresponds to the pattern 3a or 3b (the determination result is Yes in Step S14), the CPU 16 shifts the target pixel left by one subpixel in subpixels (Step S15) and expands the shifted target pixel into the subpixels (Step S18), thus reducing the occurrence of jaggies in the left diagonal lines.

In contrast, when the matching area does not correspond to the pattern 3a or 3b (the determination result is No in Step S14), the CPU 16 determines whether the matching area corresponds to a pattern 4a or 4b shown in FIG. 5(b) (Step S16). The patterns 4a and 4b are patterns for detecting right diagonal lines. When an upper-right pixel or a lower-right pixel of the target pixel is a pixel constituting the character (▪) and an upper-left pixel and a lower-left pixel of the target pixel are pixels constituting the background (□), the matching area corresponds to the pattern 4a or 4b.

The right diagonal lines are where jaggies occur in the arrangement of the bitmap fonts. Accordingly, when the matching area corresponds to the pattern 4a or 4b (the determination result is Yes in Step S16), the CPU 16 shifts the target pixel right by one subpixel in subpixels (Step S17) and expands the shifted target pixel into the subpixels (Step S18), thus reducing the occurrence of jaggies in the right diagonal lines.

When the matching area does not correspond to the pattern 4a or 4b (the determination result is No in Step S16), the target pixel is expanded into the subpixels without shift in subpixels (Step S18) and the process terminates the processing of the target pixel.

The process then returns to the flowchart shown in FIG. 2. The CPU 16 determines whether the expansion process into the subpixels is completed for all the pixels constituting the bitmap font expanded in the RAM 24 in Step S1 (Step S3). When the expansion process for all the pixels is not completed, the CPU 16 repeats the expansion process (Step S2).

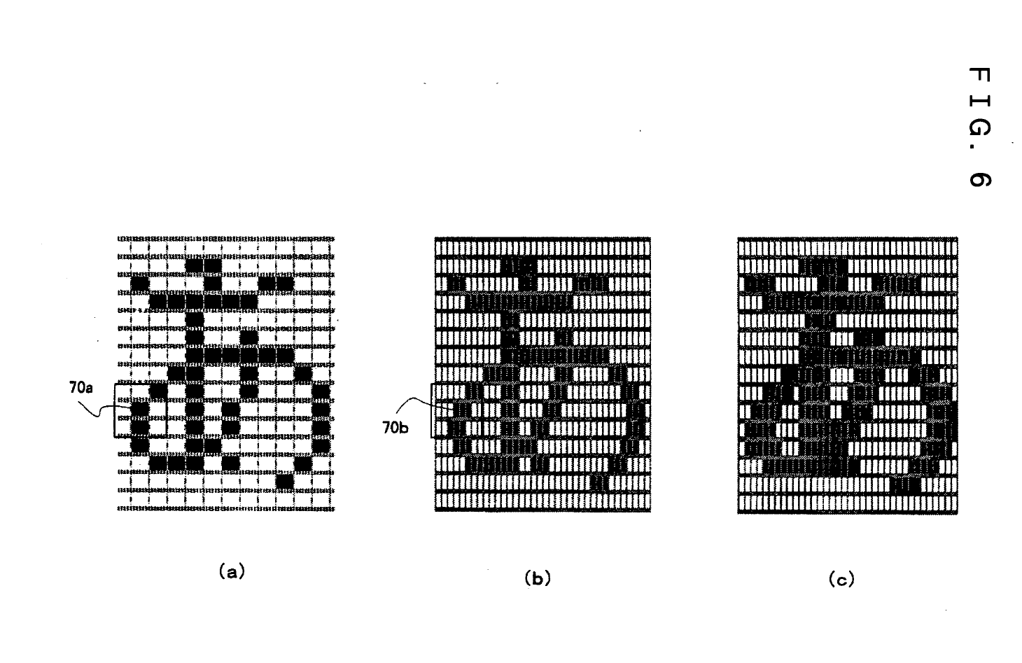

FIG. 6 includes example results before and after the expansion process into the subpixels. FIG. 6(a) shows a state in which the bitmap fonts read out from the font ROM 22 are expanded in the RAM 24. FIG. 6(b) shows data after the expansion process into the subpixels (Step S2) is performed for the corresponding bitmap font. For example, when a pixel 70a in FIG. 6(a) is the target pixel, the matching area has a right diagonal line and corresponds to the pattern 4a. Hence, after the expansion process into the subpixels, the corresponding pixel 70b is placed at a position that is shifted right by one subpixel from the position of the pixel 70a, as shown in FIG. 6(b).

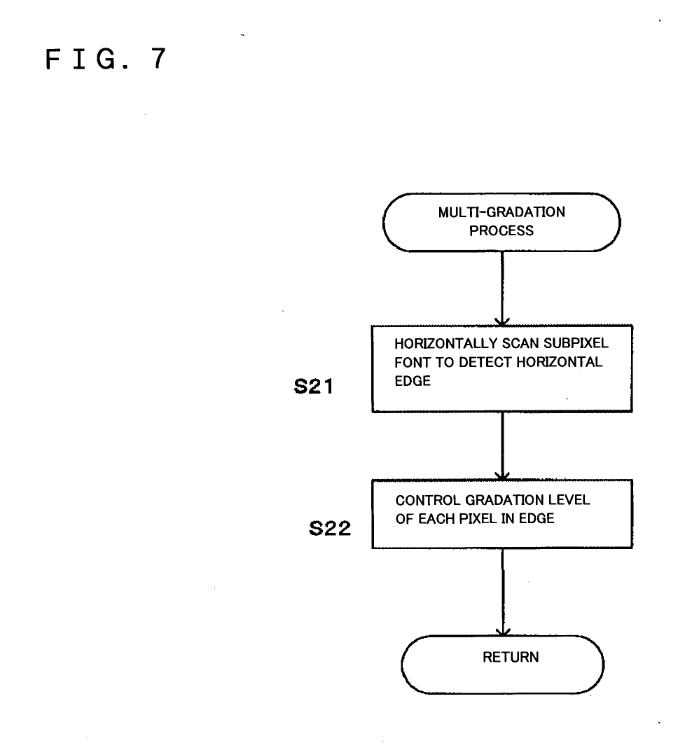

After the expansion process into the subpixels is completed for all pixels (the determination result is Yes in Step S3), the CPU 16 performs the multi-gradation process (Step S4). FIG. 7 is a flowchart of the multi-gradation process. The multi-gradation process is a process for controlling the gradation (gradation level) of each pixel in a horizontal boundary (that is, a horizontal boundary between the character and the background) that is included in the subpixel font expanded in Step S2. The multi-gradation process increases the apparent line width in the horizontal boundary and further reduces the jaggies occurring in the diagonal lines.

First, the CPU 16 horizontally scans the subpixel font that is expanded in the RAM 24 in Step S2 in order to detect horizontal edges (Step S21). A horizontal edge here is a pattern in which a pixel constituting the character (▪) is horizontally aligned with a pixel constituting the background (□), that is, a pattern ▪□ or □▪ (hereinafter also referred to as an edge pattern), so that the CPU 16 detects this edge pattern from the subpixel font.

After detecting the edge pattern, the CPU 16 increases the gradation level of the pixel constituting the character (▪) by α% and decreases the gradation level of the pixel constituting the background (□) by α% in the edge pattern (Step S22). This step gives the pixels in the edges an intermediate gradation level, thus further reducing the jaggies occurring in the diagonal lines.

The process then returns to the flowchart shown in FIG. 2. The CPU 16 determines whether the detection of the edges and the gradation-level control of the edge pattern have been performed for the entire subpixel font (Step S5). The process repeats Steps S21 and S22 until the detection and control processing is performed for the entire subpixel font. Upon completion of the detection and control processing, the process for improving the character quality is completed.

The control percentage α% of the gradation level is preferably, for example, 33%. Namely, while the gradation level of the pixels constituting the character (▪) in the edge pattern is increased by 33%, the gradation level of the pixels constituting the background (□) is decreased by 33%. The difference of the gradation level at a part where the pixel ▪ is adjacent to the pixel □ is 100% without this processing, whereas the difference of the gradation level at the part where the pixel ▪ is adjacent to the pixel □ is about 33% with this processing. In this way, controlling the gradation level (luminance) of the pixels in the edges to reduce the difference in luminance causes the jaggies in the edges of the subpixel font to fade into the background, thus reducing the occurrence of jaggies.

The value of the control percentage a of the gradation level described above is preferably varied in accordance with the characteristics of the display device (LCD panel), such as the display unit 12. Although both the percentage by which the gradation level of the pixel (▪) is increased and the percentage by which the gradation level of the pixel (□) is decreased are set to α% in the above example, one of them may be set to another percentage. Even in such a case, setting each of the percentages such that the difference in luminance becomes small between the pixel ▪ and the pixel □ has an effect of reducing the occurrence of jaggies.

FIG. 6(c) is an example of a bitmap font displayed after the multi-gradation process. The multi-gradation process decreases the difference in gradation level in the boundary to reduce the occurrence of jaggies, thus smoothly displaying the outline of the character.

As described above, the mobile terminal device according to this embodiment expands the bitmap fonts into the subpixel fonts while using the pattern matching that uses small patterns, such as 3×3 dots, to make a shift in subpixels. Accordingly, compared with the skeleton process described above, the mobile terminal device can greatly reduce the amount of arithmetic processing, thus lessening the load of the arithmetic processing and also increasing the speed of the display processing.

Furthermore, since the multi-gradation process is performed for the generated subpixel fonts to display them, the jaggies in the boundaries of characters visually fade into the background. Accordingly, characters having smooth outlines can be displayed.

While this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. Various changes may be made without departing from the spirit and scope of the invention.

1. A font processor, comprising:
a data acquiring device that acquires font data of bitmap fonts;
a subpixel-font generating device that analyzes a pixel arrangement of the font data by pattern matching to generate subpixel fonts that have data in subpixels; and
a gradation controlling device that controls gradation levels of the subpixels constituting the subpixel fonts.

2. The font processor according to claim 1, wherein, when pixels constituting the font data are adjacently arranged in a diagonal line, the subpixel-font generating device horizontally shifts the subpixels constituting the pixels by a predetermined number of subpixels.

3. The font processor according to claim 2, the subpixel-font generating device shifting the subpixels constituting the pixels left when the pixels constituting the font data are adjacently arranged in a left diagonal line, while the subpixel-font generating device shifts the subpixels constituting the pixels right when the pixels constituting the font data are adjacently arranged in a right diagonal line.

4. The font processor according to claim 1, the subpixel-font generating device placing the subpixels constituting the pixels at positions of the corresponding pixels when the pixels constituting the font data are arranged in a horizontal line or in a vertical line.

5. The font processor according to claim 1, the subpixel-font generating device performing the pattern matching using a matching pattern of 3×3 pixels.

6. The font processor according to claim 1, the gradation controlling device further comprising:
an edge detecting device that detects edges included in the subpixel fonts; and
a gradation setting device that sets gradation level of the pixels constituting the edges to an intermediate gradation level.

7. The font processor according to claim 6,
the edge detecting device detecting portions where pixels constituting a character are horizontally adjacent to pixels constituting a background as the edges, and
the gradation setting device increasing the gradation level of the pixels constituting the character by a predetermined percentage and decreasing the gradation level of the pixels constituting the background by the predetermined percentage.

8. A terminal device, comprising:
the font processor according to claim 1;
a storage device that stores font data generated by the font processor; and
a display unit that displays the font data generated by the font processor.

9. A font processing method, comprising:
acquiring font data of bitmap fonts;
analyzing a pixel arrangement of the font data by pattern matching to generate subpixel fonts that have data in subpixels; and
controlling the gradation levels of the subpixels constituting the subpixel fonts.

10. A font processing program executed in a terminal device having a computer, the program causing the computer to function as:
a data acquiring device that acquires font data of bitmap fonts;
a subpixel-font generating device that analyzes a pixel arrangement of the font data by pattern matching to generate subpixel fonts that have data in subpixels; and
a gradation controlling device that controls gradation levels of the subpixels constituting the subpixel fonts.
